(19) United States
(12) Patent Application Publication
(10) Pub. No.: US 2014/0041113 A1
(43) Pub. Date: Feb. 13, 2014

(54) Apparatus for Preventing Flatware from Passing through the Drain of a Wash Basin or Sink, and Related Methods of Use

(71) Applicant: Joe Mobbs, San Diego, CA (US)

(72) Inventor: Joe Mobbs, San Diego, CA (US)

(21) Appl. No.: 13/572,530

(22) Filed: Aug. 10, 2012

(51) Int. Cl. E03C 1/00; B08B 1/00

(52) U.S. Cl. 4/629; 134/6

(57) ABSTRACT

Disclose is a magnetized sink which (a) does not result in the congestion of a sink drain, (b) features at least one neodymium magnet, and (c) assists in the performance of sink activities that are unrelated to flatware. In one embodiment, the sink comprises: a basin; a drain; and a plurality of neodymium magnets secured to an underside of the basin whereby metallic items may be magnetically attracted to the inside the basin. In one mode of operation, the sink is configured to prevent flatware from passing over the drain precipice. In another mode of operation, the disclosed apparatus is configured to assist in the washing of pots and/or pans, wherein pots or pans are held upright via magnetic attraction.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

This specification is in the field of apparatus for preventing flatware and other metallic items from passing through the drain of a wash basin or sink, and related methods of use.

2. Background of the Invention.

Frequently, flatware and other kitchenware are washed in a sink comprising a drain. Sometimes, it is desirable to prevent flatware or the like from passing through the drain. For instance, it is desirable to prevent the passage of flatware through a sink drain to avoid flatware damage or loss. As a result, there is a need for apparatus for preventing flatware and other metallic items from passing through the drain of a wash basin or sink, and related methods of use.

Some apparatus have been developed in an attempt to meet the above identified need. For instance, U.S. Pat. 6,626,297 (issued Sep. 30, 2003) discloses a magnetized rim for a sink drain, wherein flatware and other metallic items passing over the drain precipice is magnetically secured to the drain rim and, thereby, prevented from passing into or through the drain. Although capable of magnetically securing flatware to the rim of a drain before passing therethrough, the disclosed apparatus is not entirely satisfactory for preventing flatware and other metallic items from passing through the drain of a wash basin or sink or other sink related activities. For example, the apparatus disclosed by U.S. Pat. 6,626,297 gathers flatware around and through the rim of the sink whereby the sink can become undesireably congested or clogged unless constantly monitored. For another example, the subject apparatus does not employ strong enough magnets to capture all classes of flatware. Finally, the above disclosed apparatus does not aid in the performance of other sink activities unrelated to flatware, e.g., the washing of pots and pans or other kitchenware. Accordingly, there remains a need for need for apparatus for preventing flatware and other metallic items from passing through the drain of a wash basin or sink, which apparatus (a) do not result in the congestion of the sink drain, (b) feature a strong magnet, and (c) assist in the performance of sink activities that are unrelated to flatware.

### SUMMARY OF THE INVENTION

An objective of this specification is to disclose apparatus and related methods, which apparatus and methods (a) do not result in the congestion of the sink drain, (b) feature a strong magnet, and (c) assist in the performance of sink activities that are unrelated to flatware. In one embodiment, a disclosed apparatus may be a sink comprising: a basin; a drain centrally disposed through the basin; and a plurality of neodymium magnets secured to an underside of the basin, offset from and around the drain, whereby the magnetic field of the neodymium magnets may either magnetize the basin or attract and hold metallic items to the inside the basin. In one mode of operation, the disclosed system is configured to prevent flatware from passing over the drain precipice. In another mode of operation, the disclosed apparatus is configured to assist in the washing of pots and/or pans, wherein pots or pans are held upright via magnetic attraction, whereby the a washing or scrubbing force may be applied to the pans without the pans tipping under said force.

### BRIEF DESCRIPTION OF THE FIGURES

The manner in which these objectives and other desirable characteristics can be obtained is explained in the following description and attached figures in which:

FIG. 1 is a top view of a magnetized sink;

FIG. 2 is a bottom view of the magnetized sink of FIG. 1;

FIG. 3 is a front cross-section view of the magnetized sink of FIG. 1;

FIG. 4 is a side cross-section view of the magnetized sink of FIG. 1;

FIG. 5 is a front cross-section view of the magnetized sink of FIG. 1; and

FIG. 6 is a side cross-section view of the magnetized sink of FIG. 1.

It is to be noted, however, that the appended figures illustrate only typical embodiments of the disclosed apparatus, and therefore, are not to be considered limiting of their scope, for the disclosed apparatus may admit to other equally effective embodiments that will be appreciated by those reasonably skilled in the relevant arts. Also, figures are not necessarily made to scale.

### DETAILED DESCRIPTION OF PREFERRED EMBODIMENTS

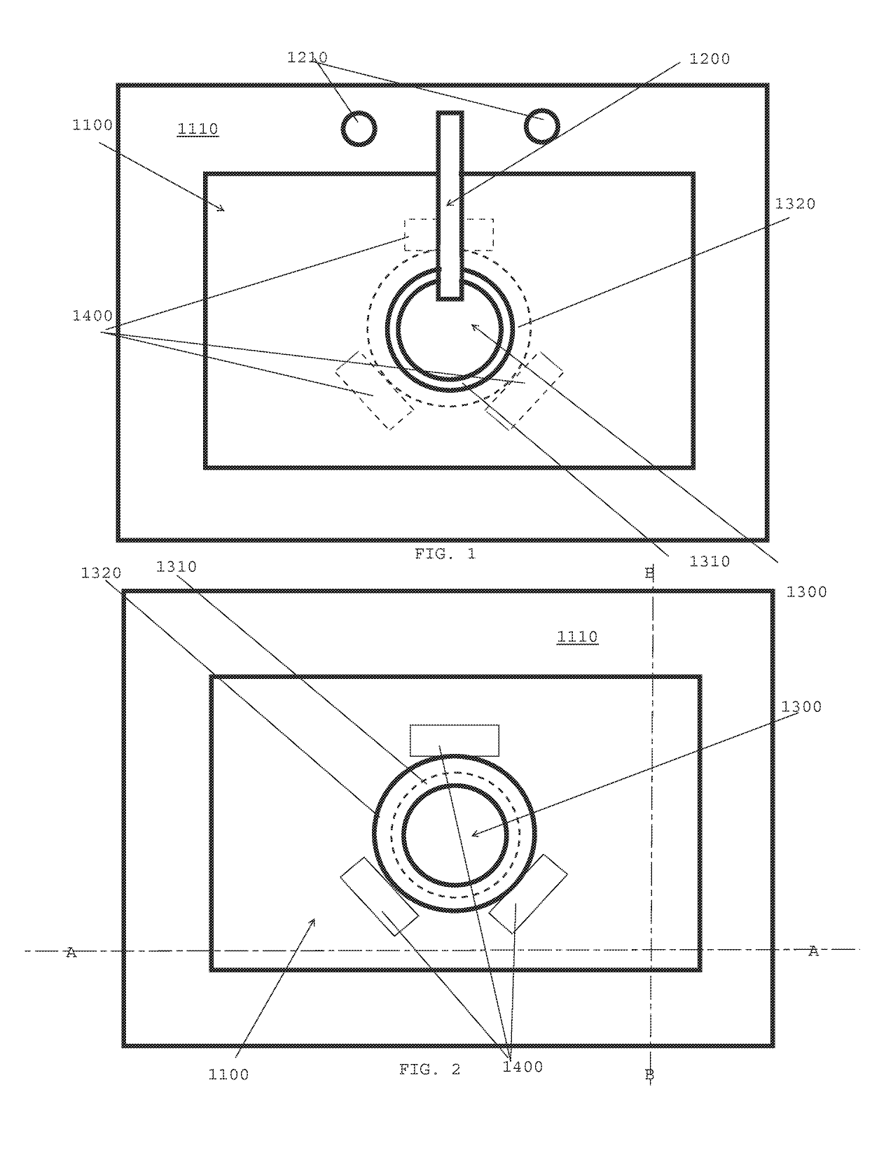

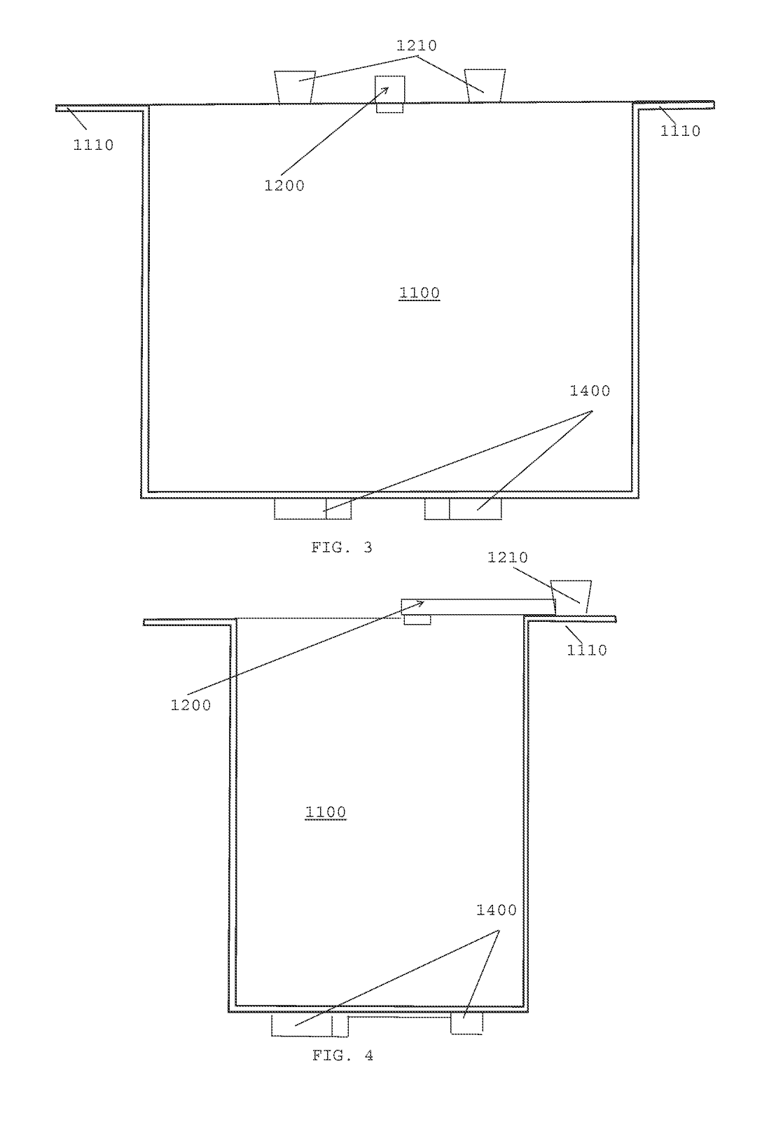

In general, disclosed is an apparatus and related methods, which apparatus and methods, among other things, (a) do not result in the congestion of the sink drain, (b) feature a strong magnet, and (c) assist in the performance of sink activities that are unrelated to flatware. The more specific features of the disclosed apparatus are described in connection with FIGS. 1 through 6.

FIGS. 1 through 4 respectively disclose top, bottom, front cross-section (taken along line A of FIG. 2), and side cross-section (taken along line B of FIG. 2) views of a magnetized sink 1000. As shown in those figures, the sink 1000 preferably comprises: a basin 1100 with a rim 1110; a faucet 1200 with hot and cold water operating controls 1210; a drain 1300 with a rim 1310 and flange 1320; and a plurality of magnets 1400 disposed around the flange 1320 of the drain 1300 on the underside of the basin 1100. In a preferable embodiment the basin 1100 is composed of stainless steel or other soft magnetic materials (e.g., steel, cast iron, copper, aluminum, or other metallic materials) and configured to retain water or other fluids supplied thereto by the faucet 1200 or other fluid source. Suitably, the drain 1300 may define an aperture through the bottom of the basin 1100 and be configured to electively remove water from the basin 1100. In the depicted embodiment, a flange 1320 is provided to the drain whereby the sink 1000 drain 1300 may be coupled to a drain pipe or garbage disposal.

Referring now to FIG. 2, a plurality of magnets 1400 may suitably be coupled to the underside of the basin 1100 at equal spacing around the flange 1320. In a preferred embodiment, the plurality of magnets 1400 are suitably three neodymium magnets, which are strong enough to magnetically attract all classes of flatware and kitchenware. In the depicted embodiment, the magnets are preferably secured to the bottom of the sink via magnetic attraction whereby the bottom of the sink basin 1100 becomes magnetized. However, in other embodiments wherein the sink is not a soft magnetic material, the magnets may be coupled to the bottom of the basin 1100 via straps or other bolting mechanisms known to those of skill in the art. Suitably, in sinks comprising non-magnetic materials, the magnetic field of the plurality of magnets may be provided through the walls of the basin. Non-magnetic materials that may suitably be used for the basin 1100 of the sink 1000 include, but are not limited to, ceramic, marble, plastic, soapstone, concrete, terrazzo, wood, stone, glass, granite, or the like.

In one mode of operation, the sink 1000 may be used for washing flatware and other metallic objects. Suitably, the sink 1000 is configured to prevent flatware from passing over the drain 1200 rim 1210. Said configuration is a result of the basin 1100 being magnetized via the plurality of magnets 1400 which either magnetize the basin 1100 or provide a magnetic field through the basin. In one embodiment, the described mode of operation may be accomplished by the steps of: first, locating at least one piece of metallic flatware; second, washing the piece of flatware in the sink basin; and third, adhering the flatware to the bottom of the basin via magnetic attraction. Suitably the basin 1100 is either magnetized or the magnets are spaced from the rim 1310 of the drain 1300 so that flatware is prevented from congesting or clogging the drain 1300.

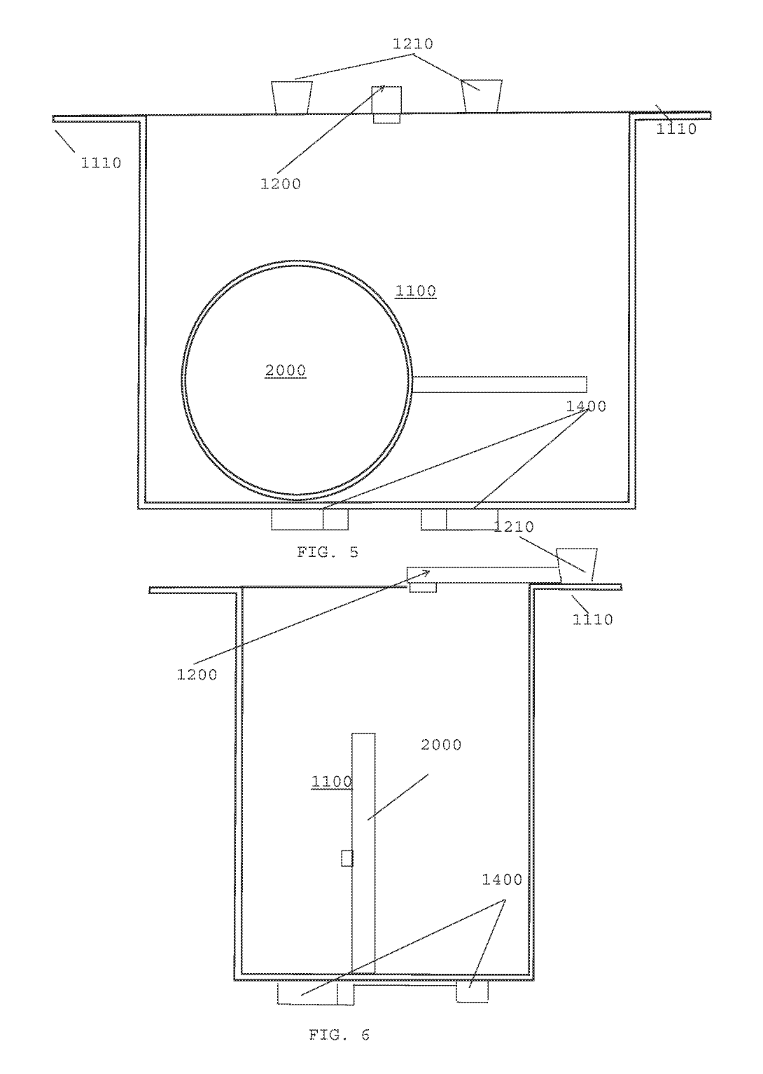

In another mode of operation, the disclosed apparatus is configured to assist in the washing of pots and/or pans. Suitably, pots or pans may be held upright via their magnetic attraction to the neodymium magnets or basin. Preferably, a washing or scrubbing force may be applied to the pans without the pans tipping under said force. FIGS. 5 and 6 are cross sections of a sink (taken along lines A and B respectively in FIG. 2) and illustrate said mode of operation. Referring to those figures, said mode of operation may be accomplished by the steps of: first, uprightly positioning a pan 2000 in the basin 1100 of the sink 1000; second, applying a washing or scrubbing force to the pan 2000 while the pan 2000 is held upright via its magnetic attraction to the basin 1100 or magnets 1400; and third, removing the pan 2000 from the basin 1100.

It should be noted that FIGS. 1 through 6 and the associated description are for illustrative purposes only. In other words, the depiction and descriptions of the present invention should not be construed as limiting of the subject matter in this application. Additional modifications and variations within the scope of the invention may become apparent to one skilled in the art after reading this disclosure.

I claim:

1. A wash basin with a drain, said washbasin being magnetized by a plurality of magnets adhered to an underside thereof via magnetic attraction thereto.

2. A sink comprising:
a basin with a rim;
a faucet with controls provided through the rim of the basin;
a drain disposed in the basin, said drain featuring a rim and flange; and, at least one magnet disposed around the flange on an underside of said basin.

3. The sink of claim 2 wherein said at least one magnet is a neodymium magnet.

4. The sink of claim 2 wherein said at least one magnet is three magnets.

5. The sink of claim 4 wherein said three magnets are neodymium.

6. The sink of claim 5 wherein said three magnets are evenly spaced around the flange on the underside of the basin.

7. The sink of claim 6 wherein the basin is formed of a material that is a soft magnetic material.

8. The sink of claim 6 wherein the basin is formed of a metallic material.

9. A method of washing a pan comprising the steps of:
obtaining the pan;
obtaining a magnetized wash basin;
uprightly positioning the pan in the wash basin;
applying a washing force to a surface of the pan while said pan is uprightly held via magnetic attraction to the magnetized wash basin; and,
removing the pan from the basin.

10. The method of claim 9 wherein the magnetized wash basin comprises:
a basin with a rim;
a faucet with controls provided through the rim of the basin;
a drain disposed in the basin, said drain featuring a rim and flange; and,
at least one magnet disposed around the flange on an underside of said basin.

11. The method of claim 10 wherein said at least one magnet is a neodymium magnet.

12. The method of claim 10 wherein said at least one magnet is three magnets.

13. The method of claim 12 wherein said three magnets are neodymium.

14. The method of claim 13 wherein said three magnets are evenly spaced around the flange on the underside of the basin.

15. The method of claim 14 wherein the basin is formed of a material that is a soft magnetic material.

16. The method of claim 15 wherein the basin is formed of a metallic material.

17. The wash basin of claim 1 comprising:
a basin with a rim;
a faucet with controls provided through the rim of the basin;
the drain disposed in the basin, said drain featuring a rim and flange; and,
at least one magnet disposed around the flange on an underside of said basin.

18. The wash basin of claim 1 wherein said at least one magnet is a neodymium magnet.

19. The wash basin of claim 1 wherein said at least one magnet is three magnets.

20. The wash basin of claim 19 wherein said at least three magnets are neodymium magnets.
